(19) United States
(12) Patent Application Publication
(10) Pub. No.: US 2012/0306667 A1
(43) Pub. Date: Dec. 6, 2012

(54) DIGITAL AUDIO WARNING SYSTEM

(76) Inventors: JONATHAN ERLIN MORITZ, Bear, DE (US); John Alton Moritz, Towsend, DE (US)

(21) Appl. No.: 13/151,744

(22) Filed: Jun. 2, 2011

(51) Int. Cl. G08B 23/00; G08B 21/00

(52) U.S. Cl. 340/963; 340/540

(57) ABSTRACT

A digital audio warning system (DAWS) that can monitor all relative aircraft systems and provide audio for any warning that requires immediate action. Current aircraft systems only monitor their individual system. The DAWS can monitor all relative aircraft systems. The DAWS may not replace the conventional warning signals, but can be a second level of warning to the flight crew. These warnings are relative to “red flag” type warnings and are not meant to replace warnings such as traffic collision avoidance system (TCAS) or enhanced ground proximity warning system (EGPWS) warnings.

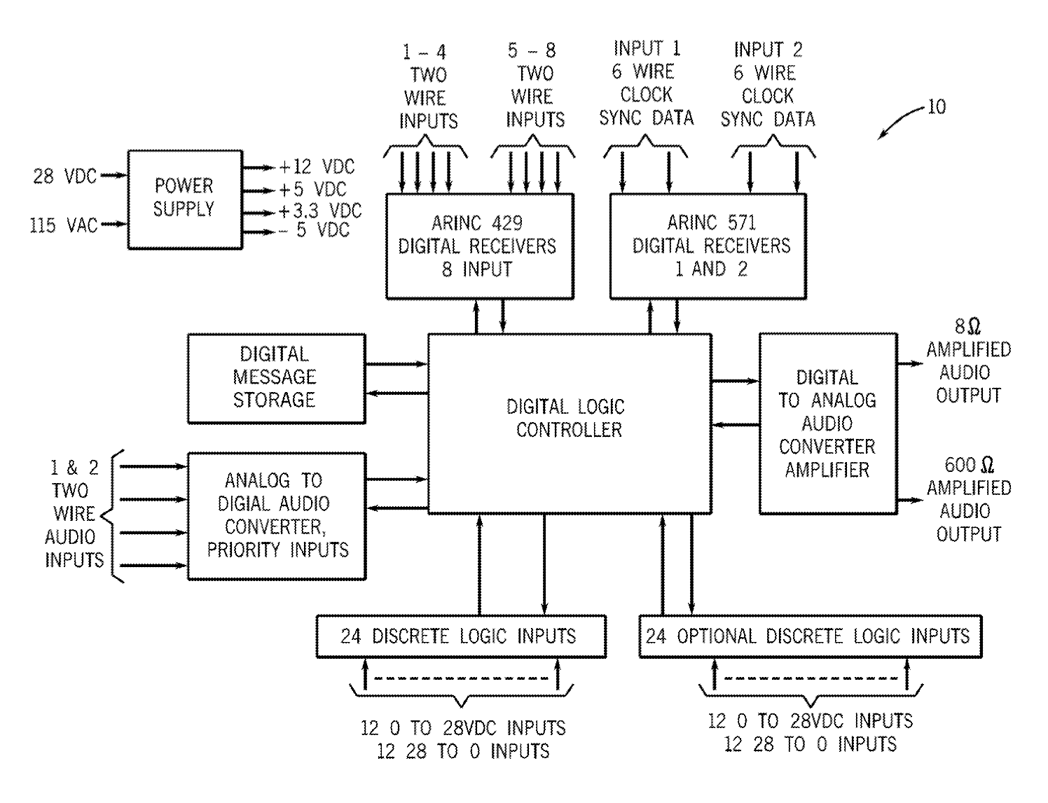

### BACKGROUND OF THE INVENTION

The present invention relates to digital audio warning systems and, more particularly, to digital audio warning systems that provide flight crew with audio announcements of immediate action annunciations in the aircraft.

Aircraft have several systems that have various warnings that are typically made known to flight crew by the individual system's audio or visual annunciation. Most systems simply use a light in the flight deck. Current aircraft systems only monitor their system, without integrating other systems. Most aircraft systems use a red annunciator in the aircraft. For example, if NAV1 fails, a fed flag is lit to show that NAV1 has failed.

As can be seen, there is a need for a system to monitor all relative aircraft systems and provide audio for any warning that requires immediate action.

### SUMMARY OF THE INVENTION

In one aspect of the present invention, a digital audio warning system comprises one or more receivers, the receivers adapted to monitor a plurality of systems; one or more discrete logic inputs, the discrete logic inputs adapted to monitor one or more discrete systems; a digital logic controller adapted to receive signals from the one or more receivers and the one or more discrete logic inputs; and a digital to analog audio converter and amplifier for delivering an audio alert to a user when the digital logic controller determines the audio alert is warranted.

In another aspect of the present invention, a digital audio warning system for an aircraft comprises an ARINC 429 digital receiver adapted to monitor various systems of the aircraft; an ARINC 571 digital receiver adapted to monitor other various systems of the aircraft; a set of discrete logic inputs adapted to monitor discrete aircraft systems; a digital logic controller adapted to receive signals from the ARINC 429 digital receiver, the ARINC 571 digital receiver and the set of discrete logic inputs, the digital logic controller further adapted to process the signals to determine whether an audio alert is warranted; and a digital to analog audio converter and amplifier adapted to deliver the audio alert to a user.

These and other features, aspects and advantages of the present invention will become better understood with reference to the following drawing, description and claims.

### BRIEF DESCRIPTION OF THE DRAWINGS

The FIGURE is a schematic view of an audio warning system according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a digital audio warning system (DAWS) that can monitor all relative aircraft systems and provide audio for any warning that requires immediate action. Current aircraft systems only monitor their individual system. The DAWS of the present invention can monitor all relative aircraft systems. The DAWS of the present invention may not replace the conventional warning signals, but can be a second level of warning to the flight crew. These warnings are relative to “red flag” type warnings and are not meant to replace warnings such as traffic collision avoidance system (TCAS) or enhanced ground proximity warning system (EGPWS) warnings.

Referring to the FIGURE, a digital audio warning system (DAWS) 10 includes a power supply that may receive 28 volt direct current (VDC) and 115 volt alternating current (VAC) from the aircraft power busses (not shown). The power supply may supply power for the DAWS 10, including, for example, +12 VDC, +5 VDC, +3.3 VDC and −5 VDC.

The DAWS 10 may include Aeronautical Radio, Incorporated (ARINC) receivers, discrete logic inputs, and digital storage. The DAWS 10 may monitor multiple systems by receiving inputs from the ARINC 429, ARINC 517 and also discrete inputs from some systems. For the ARINC 429 and 517, the DAWS 10 may monitor for certain data on specific labels and, if those instants become true, the DAWS 10 may send audio out, depending on the label. For the discrete inputs, the DAWS 10 may send audio depending on which port sets to True. The

DAWS 10 may include, for example, a set of 24 discrete logic inputs, as shown in the FIGURE. This set of 24 discrete logic inputs may include 12—zero to 28 volt DC inputs and 12-28 to zero volt DC inputs. Optionally, an additional set of 24 discrete logic inputs may be permitted. This additional set of 24 discrete logic inputs may include 12—zero to 28 volt DC inputs and 12-28 to zero volt DC inputs. The data from the discrete logic inputs and the ARINC receivers may be fed to a digital logic controller, which may process the information received and determine whether an alert is warranted.

When an alert is warranted, a digital to analog audio converter and amplifier may be used to receive a signal from the digital logic controller and broadcast an audio alert. The alert may be sent out, for example, as an 8 ohm amplified audio output or as a 600 ohm amplified audio output.

The DAWS 10 may be configured, for example, on one or more circuit boards which use software to control their function. The software may control the digital logic controller and may define when an alert is warranted. The software may receive the inputs from the various systems (via the ARINC receivers and the discrete logic inputs, for example), gather all of the priorities of the various systems, monitor various discrete databases and issue alerts as needed.

While the DAWS 10 described above is used in aircraft systems, the DAWS 10 may also be used in other systems that have sensors and the like that could be reported to the user via audio.

It should be understood, of course, that the foregoing relates to exemplary embodiments of the invention and that modifications may be made without departing from the spirit and scope of the invention as set forth in the following claims.

What is claimed is:

1. A digital audio warning system comprising:
one or more receivers, the receivers adapted to monitor a plurality of systems;
one or more discrete logic inputs, the discrete logic inputs adapted to monitor one or more discrete systems;
a digital logic controller adapted to receive signals from the one or more receivers and the one or more discrete logic inputs; and
a digital to analog audio converter and amplifier for delivering an audio alert to a user when the digital logic controller determines the audio alert is warranted.

2. The digital audio warning system of claim 1, wherein the plurality of systems and the one or more systems are aircraft systems.

3. The digital audio warning system of claim 2, wherein the one or more receivers include an ARINC 429 and an ARINC 571 digital receiver.

4. The digital audio warning system of claim 2, wherein the one or more discrete logic inputs include 24 discrete logic inputs, including 12—zero to 28 volt DC inputs and 12-28 to zero volt DC inputs.

5. The digital audio warning system of claim 2, further comprising two sets of discrete logic inputs, each set including 24 discrete logic inputs.

6. The digital audio warning system of claim 1, wherein the digital logic controller monitors the one or more digital receivers and the one or more discrete logic inputs simultaneously.

7. The digital audio warning system of claim 1, further comprising computer software having program code adapted to control a processor of the digital logic controller.

8. The digital audio warning system of claim 1, wherein the one or more digital receivers, the one or more discrete logic inputs and the digital to analog audio converter and amplifier are disposed on one or more printed circuit boards.

9. A digital audio warning system for an aircraft, comprising:
an ARINC 429 digital receiver adapted to monitor various systems of the aircraft;
an ARINC 571 digital receiver adapted to monitor other various systems of the aircraft;
a set of discrete logic inputs adapted to monitor discrete aircraft systems;
a digital logic controller adapted to receive signals from the ARINC 429 digital receiver, the ARINC 571 digital receiver and the set of discrete logic inputs, the digital logic controller further adapted to process the signals to determine whether an audio alert is warranted; and
a digital to analog audio converter and amplifier adapted to deliver the audio alert to a user.

10. The digital audio warning system of claim 9, wherein the digital logic controller monitors the digital receivers and set of discrete logic inputs simultaneously.
